(19) United States
(12) Patent Application Publication
(10) Pub. No.: US 2004/0032896 A1
(43) Pub. Date: Feb. 19, 2004

(54) Miniaturized multi-functional laser resonator

(75) Inventors: Ashok B. Patel, Cerritos, CA (US); Ronald P. CdeBaca, Hawthorne, CA (US)

Correspondence Address: PATENT DOCKET ADMINISTRATION, RAYTHEON SYSTEMS COMPANY, P.O. BOX 902 (E1/E150), BLDG E1 M S E150, EL SEGUNDO, CA, 90245-0902, US

(73) Assignee: RAYTHEON COMPANY

(21) Appl. No.: 10/222,603

(22) Filed: Aug. 15, 2002

(51) Int. Cl. H01S 3/04; H01S 3/08

(52) U.S. Cl. 372/107; 372/36

(57) ABSTRACT

A miniaturized multi-functional laser resonator (10). The novel invention includes a mobile optical bench (100), a predetermined number of laser sources (34, 50, 54, 58) mounted to the optical bench (100), and a plurality of optical elements (80) for combining laser beams output from the laser sources such that the beams converge on a small area, such as a telescope (20). The invention further includes a mechanism (102) for aligning the laser beams. In the illustrative embodiment, the mechanism for aligning the beams includes v-grooved mounting surfaces (102) formed in the optical bench (100). The optical elements (80) are mounted in the v-grooved surfaces (102) of the optical bench (100) such that the laser beams are aligned. In the illustrative embodiment, the invention includes four laser diodes generating 1053 nM, 905 nM, 850 nM, and 650 nM laser beams. In the preferred embodiment, the optical elements include rectangular optical flat elements that are appropriately coated to transmit or reflect the various wavelengths of the laser beams, or a multi-faceted bonded prism.

### BACKGROUND OF THE INVENTION

1. Field of the Invention:

The present invention relates to optical systems. More specifically, the present invention relates to multi-functional laser resonators.

2. Description of the Related Art:

Current and future military applications will use lasers for several different functions. For example, a rifle being carried by a soldier may be equipped with systems for combat identification, laser range finding, infrared training exercises, pointing and targeting, and visible aiming and boresighting. Each function would require a laser operable at a different wavelength.

Current conventional opto-mechanical designs for multiple laser wavelengths and functions use individual mounts where each sub-assembly must be installed and aligned separately. This method tends to be complex, heavy, bulky, and costly when used to combine several functions. Such a large and heavy system might limit the range and mobility of a soldier.

A compact, lightweight laser design is disclosed in U.S. Pat. No. 5,923,695, issued Jul. 13, 1999, to A. B. Patel and M. P. Palombo and entitled “Compact Pumped Laser Resonator and Method”, the teachings of which are incorporated herein by reference. This laser, however, may be unsuitable for many applications due to its limited range.

Hence, a need exists in the art for a compact, lightweight, multi-purpose infrared laser.

### SUMMARY OF THE INVENTION

The need in the art is addressed by the miniaturized multi-functional laser resonator of the present invention. The invention includes a mobile optical bench, a predetermined number of laser sources mounted to the optical bench, and a plurality of optical elements for combining laser beams output from the laser sources.

In the illustrative implementation, the beams are combined in such a way that the beams converge on a small area, such as a telescope. The invention further includes a mechanism for aligning the laser beams. In the illustrative embodiment, the mechanism for aligning the beams includes v-grooved mounting surfaces formed in the optical bench. The optical elements are mounted in the v-grooved surfaces such that the laser beams are aligned. In the illustrative embodiment, the invention includes four laser diodes generating 1053 nM, 905 nM, 850 nM, and 650 nM laser beams. In the preferred embodiment, the optical elements include rectangular optical flat elements that are appropriately coated to transmit or reflect the various wavelengths of the laser beams, or a multi-faceted bonded prism.

### BRIEF DESCRIPTION OF THE DRAWINGS

FIG. 1 is an optical schematic of the miniaturized multi-functional laser resonator of the present invention.

FIG. 2 is an optical schematic of the first laser generator.

FIG. 3 is an optical schematic of the second laser generator.

FIG. 4 is an optical schematic of the receiver, beam splitter, and telescope.

FIG. 5 is an illustration of the optical bench of the present invention.

FIG. 6 is an illustration of an illustrative embodiment of the laser resonator of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

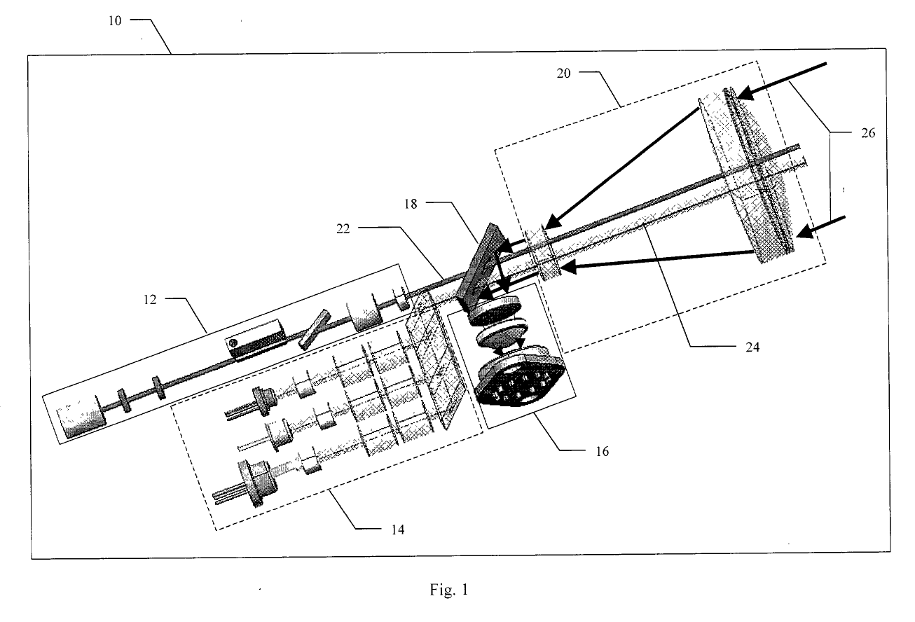

FIG. 1 is an optical schematic of the miniaturized multi-functional laser resonator 10 of the present invention. The novel laser resonator includes a first laser generator 12, a second laser generator 14, a receiver 16, a beam splitter 18, and telescope optics 20. The first laser generator 12 outputs a first laser beam 22 which is transmitted by the beam splitter 18 to the telescope 20. The second laser generator 14 outputs a second laser beam 24 which is transmitted by the beam splitter 18 to the telescope 20. Input radiation 26 is received by the telescope 20 and reflected by the beam splitter 18 to the receiver optics 16.

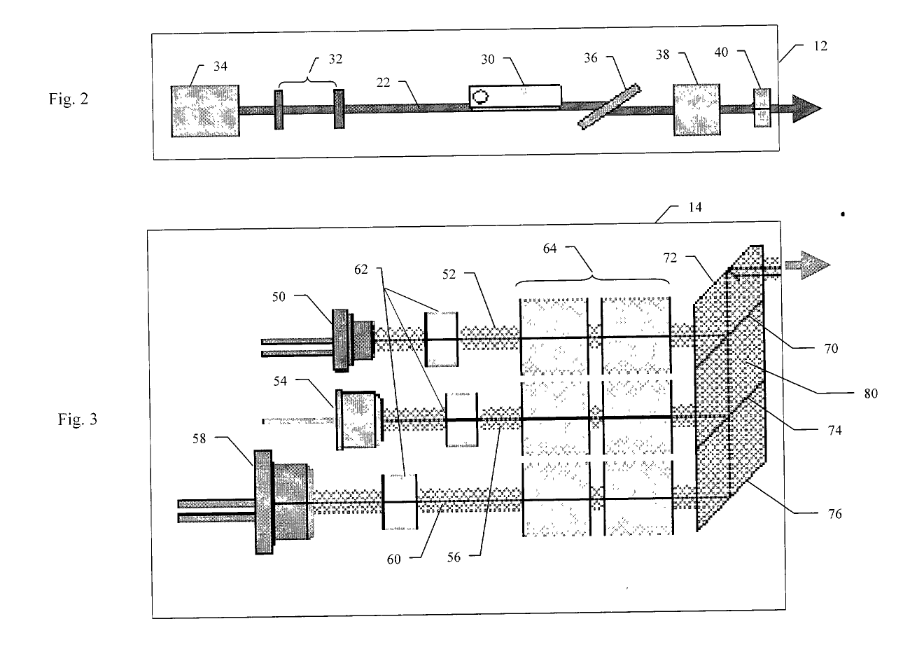

FIG. 2 is an optical schematic of the first laser generator 12. In the illustrative embodiment, the first laser generator 12 outputs an eye-safe laser beam at 1053 nM suitable for functions such as a laser range finder. The laser generator 12 includes a laser diode/laser rod 30 which outputs a laser beam 22. The laser beam 22 passes through alignment wedges 32 for aligning the laser beam 22 with mirror 34 and the output coupler 38. The beam 22 is then reflected off a mirror 34 and makes a second pass through the alignment wedges 32 and the laser rod 30. The beam 22 passes through a passive Q switch 36, output coupler 38, and collimating lens 40, and is output to the beam splitter 18 (shown in FIG. 1).

FIG. 3 is an optical schematic of the second laser generator 14. In the illustrative embodiment, the second laser generator 14 combines the outputs from three separate laser sources: a first laser diode 50 outputting a 905 nM laser beam 52 suitable for MILES training exercises or near IR pointing/targeting, a second laser diode 54 outputting an 850 nM laser beam 56 suitable for CIDDS interrogation, and a third laser diode 58 outputting a 650 nM laser beam 60 suitable for visible aiming/boresighting. Each laser beam (52, 56, 60) passes through a collimating lens 62 and alignment wedges 64. The alignment wedges 64 are optical wedges used for co-aligning the visible and IR beams to the eye safe beam 22.

The three laser beams (52, 56, 60) are combined using simple, rectangular optical flat elements that are appropriately coated to transmit or reflect the various wavelengths. The 905 nM beam 52 is reflected off a first surface 70 coated to reflect energy at 905 nM and transmit at 850 nM and 650 nM. The 905 nM beam 52 is then reflected off a second surface 72 coated to reflect all three wavelengths, and output to the beam splitter 18 (shown in FIG. 1). The 850 nM beam 56 is reflected off a third surface 74 coated to reflect energy at 850 nM and transmit at 650 nM. The 850 nM beam 56 is then transmitted through the first surface 70 and reflected off the second surface 72 to the beam splitter 18. The 650 nM beam 60 is reflected off a fourth surface 76 coated to reflect energy at 650 nM. The 650 nM beam 60 is then transmitted through the first and third surfaces (70, 74) and reflected off the second surface 72 to the beam splitter 18. A multi-faceted bonded prism 80 may be used as an alternative to rectangular optical flat elements to combine the three laser beams (52, 56, 60).

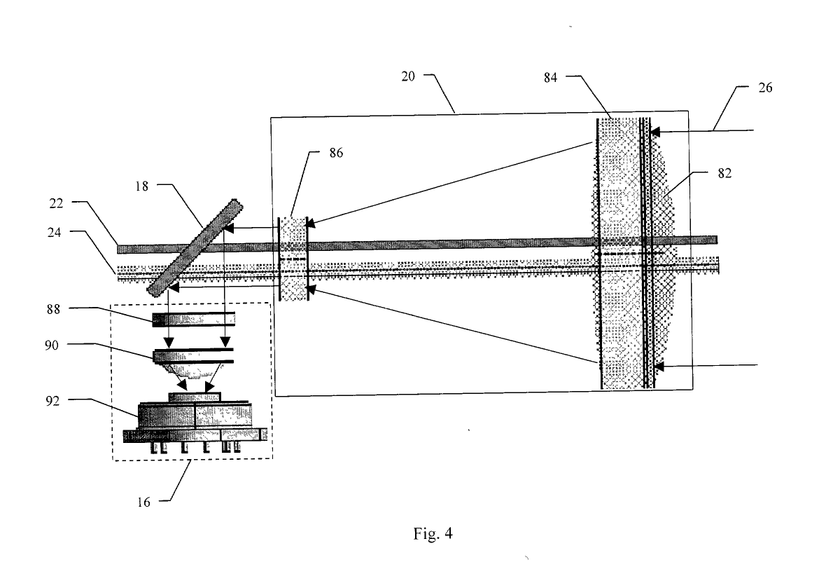

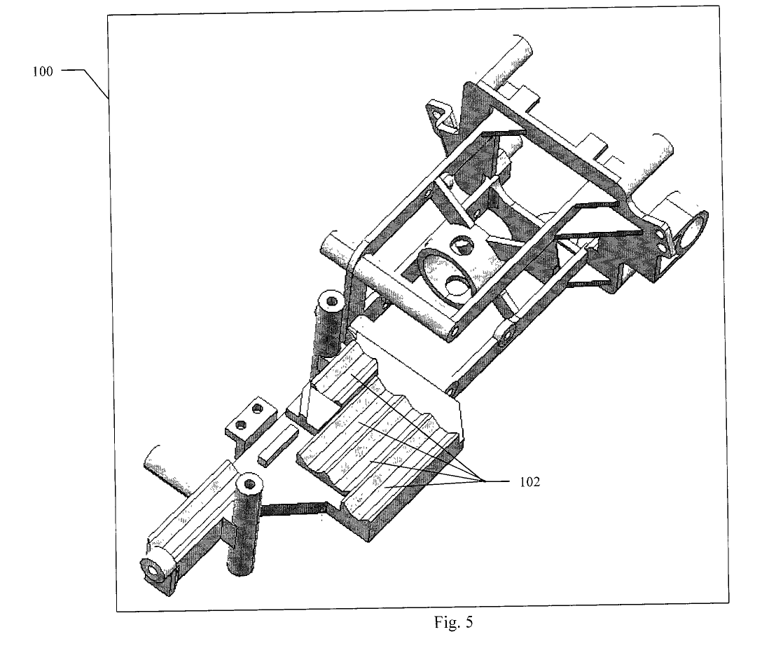

FIG. 4 is an optical schematic of the receiver 16, beam splitter 18, and telescope 20. In the illustrative embodiment, the telescope 20 includes three lenses (82, 84, 86). Incident energy received by the telescope is reflected off the beam splitter 18 to the receiver optics 16. The receiver optics 16 include a filter 88, a focusing lens 90, and a receiver detector 92. The beam splitter 18 also transmits the laser beams (22, 24) from the first and second laser generators (12, 14) to the telescope 20. Hence, the transmit and receive paths will utilize a common telescope and external aperture.

In accordance with the teachings of the present invention, all parts and subassemblies are mounted on a single, miniaturized optical bench with v-grooved mounting surfaces. FIG. 5 is an illustration of the optical bench 100 of the present invention, pointing out the novel v-grooves 102. The cylindrical optical components are dropped in the v-grooves such that they self-align to the same center. This precision optical bench ensures that parts in the same v-groove are self-aligned to each other requiring virtually no adjustments or slight rotation of the optical wedges. The self-aligning arrangement of the present invention allows for a more compact system, eliminating the larger fixtures required in conventional non-self-aligning laser resonators.

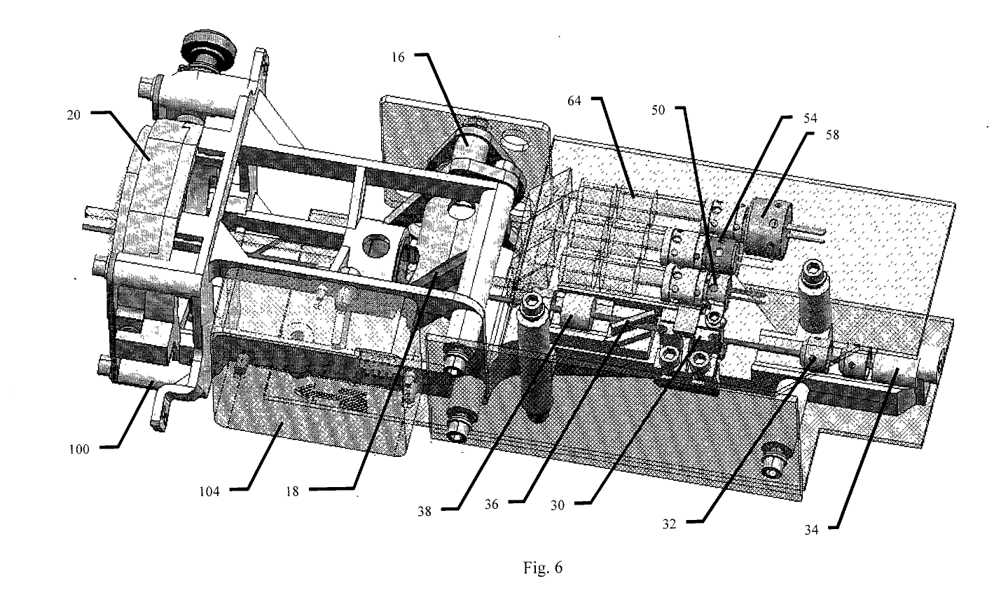

FIG. 6 is an illustration of an illustrative embodiment of the laser resonator of the present invention, showing the optical elements mounted to the optical bench 100. In the illustrative embodiment, the system further includes a miniaturized digital compass assembly 104. The complete laser resonator assembly is less than 4.8″ L×2.9″ W×2.3″ H and weighs less than 7.5 ounces. It is light enough and rugged enough to be mounted on small arms ranging from the 5.56 mm M4 to the .50 caliber M2 to the 40 mm MK19 machine gun.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A multi-functional laser resonator comprising:
a mobile optical bench;
a predetermined number of laser sources mounted to said optical bench; and
first means for combining laser beams output from said laser sources.

2. The invention of claim 1 wherein said first means includes a plurality of optical elements.

3. The invention of claim 1 wherein said invention further includes second means for aligning said laser beams.

4. The invention of claim 3 wherein said second means includes v-grooved mounting surfaces formed in said optical bench.

5. The invention of claim 4 wherein said optical elements are mounted in said v-grooved surfaces such that the laser beams are aligned.

6. The invention of claim 2 wherein said optical elements include rectangular optical flat elements that are appropriately coated to transmit or reflect the various wavelengths of said laser beams.

7. The invention of claim 2 wherein said optical elements include a multi-faceted bonded prism.

8. The invention of claim 1 wherein said predetermined number of laser sources is three or more.

9. The invention of claim 1 wherein said laser sources include a laser diode for generating an eye-safe 1053 nM laser beam.

10. The invention of claim 1 wherein said laser sources include a laser diode for generating a 905 nM laser beam.

11. The invention of claim 1 wherein said laser sources include a laser diode for generating an 850 nM laser beam.

12. The invention of claim 1 wherein said laser sources include a laser diode for generating a 650 nM laser beam.

13. The invention of claim 1 wherein said laser beams converge on a telescope.

14. The invention of claim 13 wherein said laser resonator further includes a beam splitter for transmitting said laser beams to said telescope and reflecting incoming energy received by said telescope.

15. The invention of claim 14 wherein said laser resonator further includes a receiver for receiving said incoming energy.

16. The invention of claim 1 wherein said laser resonator further includes an optional digital compass assembly.

17. A method for packaging a multi-functional laser resonator including the steps of:
providing a mobile optical bench;
mounting a predetermined number of laser sources to said optical bench; and
combining laser beams output from said laser sources.
